(19) United States
(12) Patent Application Publication
(10) Pub. No.: US 2025/0120344 A1
(43) Pub. Date: Apr. 17, 2025

(54) CROP CULTIVATION APPARATUS EQUIPPED WITH STACKABLE CULTIVATION MODULES

(71) Applicant: AG-UNI Co.,Ltd, Gyeongsan-si (KR)

(72) Inventor: MIJIN GWON, Gyeongsan-si (KR)

(21) Appl. No.: 18/524,092

(22) Filed: Nov. 30, 2023

(30) Foreign Application Priority Data
Oct. 13, 2023 (KR) 10-2023-0136757

(51) Int. Cl. A01G 9/02; A01G 9/24

(52) U.S. Cl. CPC A01G 9/023; A01G 9/246; A01G 9/247

(57) ABSTRACT

A crop cultivation apparatus includes: a shelf case composed of one or more layers, and provided with loading spaces in the respective layers; one or more cultivation modules disposed in the loading spaces of the shelf case, and configured to provide respective cultivation spaces for cultivating soil crops therein; a solution supply line extending to the individual layers of the shelf case, branched to the individual cultivation modules, and configured to supply a nutrient solution to the cultivation spaces; and a solution discharge line extending to the individual layers of the shelf case, branched to the individual cultivation modules, and configured to discharge a nutrient solution from the cultivation spaces. Each of the cultivation modules includes one or more stackable accommodation parts and a support part. The stackable accommodation parts are provided in a modular form to adjust the height of the first space.

### CROSS-REFERENCE TO RELATED APPLICATION

This application claims the benefit of Korean Patent Application No. 10-2023-0136757 filed on Oct. 13, 2023, which is hereby incorporated by reference herein in its entirety.

### BACKGROUND

### 1. Technical Field

The present invention relates to a crop cultivation apparatus equipped with stackable cultivation modules that can adjust the size of a cultivation space in the vertical direction depending on the length of soil crops.

### 2. Description of the Related Art

As living spaces and farmland are becoming narrower due to population growth and industrialization, efforts to cultivate a large quantity of flowers and vegetables in a small area are being carried out in various fields. Furthermore, as the residential form in large cities is converted from single and multi-family houses to apartments, there are a growing number of people who feel like being in the garden of a detached house and utilize plant cultivation for hobbies or decoration by cultivating plants such as flowering plants and flowers on the veranda of an apartment house or in the inside of a building.

In general, to cultivate plants on the veranda of an apartment house or in the inside of a building, there is a method of cultivating plants in a cultivation box. Since a common cultivation box is intended to be installed on the ground, there is a problem in that a large cultivation space is unnecessarily occupied and thus space utilization is inefficient. Furthermore, when the space of the veranda of an apartment house or the inside of a building is narrow, the number of plants that can be cultivated is limited.

In order to overcome these problems, a plant cultivation apparatus in which a plurality of flowerpots are vertically stacked on top of each other or are arranged in a horizontal space has been developed. However, this conventional plant cultivation apparatus has disadvantages in that the spaces between flowerpots cannot be utilized and it is inconvenient to take out plants planted in flowerpots and plant new plants.

In particular, the conventional plant cultivation apparatus using stacked flowerpots has shortcomings in that the structure thereof is complicated, the equipment cost thereof is high, and a deformed module or frame cannot be easily changed. Furthermore, the conventional plant cultivation apparatus has a structure in which flowerpots are stacked on top of each other, so that it is difficult to provide even lighting for each flowerpot and management such as the supply and discharge of a nutrient solution is cumbersome, with the result that the conventional plant cultivation apparatus is not widely utilized.

Furthermore, in the case of recently introduced crop cultivation apparatuses, most of them are suitable for the cultivation of hydroponic crops due to efforts to utilize space efficiently. These crop cultivation apparatuses have a structure in which a nutrient solution continuously flows along a flow path, so that this structure is suitable for plant-type cultivation apparatus design, but has a disadvantage in that only crops that can be grown hydroponically can be cultivated therein. In particular, in the case of hemp having high efficiency and crops used in medicine, the efficient cultivation thereof cannot be achieved through hydroponic cultivation due to poor nutrient supply, and they need to be cultivated through soil cultivation. Crop cultivation apparatuses suitable for soil cultivation have a problem in that the spatial efficiency for cultivation is low.

In particular, in the case of soil crops, the size of a cultivation space needs to vary depending on the length of the roots or stems of crops. However, most crop cultivation apparatuses have a problem in that they are not suitable to grow crops with long roots or long stems other than general soil crops because the sizes of cultivation spaces are formed to be uniform or the same.

Related art literature for the conventional crop cultivation apparatus is as follows:
Patent document: Korean Patent No. 10-2012-0007420 entitled “Stacked Drawer-type Plant Cultivation Apparatus”

### SUMMARY

The present invention has been conceived to overcome the above-described problems, and an object of the present invention is to provide a crop cultivation apparatus equipped with stackable cultivation modules that can adjust the size of a cultivation space.

According to an aspect of the present invention, there is provided a crop cultivation apparatus including: a shelf case composed of one or more layers, and provided with loading spaces in the respective layers; one or more cultivation modules disposed in the loading spaces of the shelf case, and configured to provide respective cultivation spaces for cultivating soil crops therein; a solution supply line extending to the individual layers of the shelf case, branched to the individual cultivation modules, and configured to supply a nutrient solution to the cultivation spaces; and a solution discharge line extending to the individual layers of the shelf case, branched to the individual cultivation modules, and configured to discharge a nutrient solution from the cultivation spaces; wherein each of the cultivation modules includes: one or more stackable accommodation parts each formed in a box shape with an open top and bottom, and each provided with a first space formed therein and a coupling portion formed at the lower end thereof; and a support part formed in a box shape with an open top, and provided with a second space that communicates with the cultivation space of the cultivation module when the top thereof is coupled to the coupling portion of another stackable accommodation part; and wherein the stackable accommodation parts are provided in a modular form so that the height of the first space can be adjusted in such a manner that the stackable accommodation parts are stacked on top of each other in the vertical direction by fitting the coupling portion into the top of another stackable accommodation part.

Each of the stackable accommodation part may include a case portion formed in a rectangular box shape with an open top and bottom and provided with the first space disposed therein; the coupling portion may be formed to have a section that is narrower than the section of the case portion at the lower end of the case portion; and the stackable accommodation parts may be stacked on top of each other by fitting the coupling portion of another stackable accommodation part into the top of the case portion.

The cultivation module may further include a solution pipe part configured such that one end thereof is connected to the solution supply line and the other end thereof is connected to the stackable accommodation part so that the other end of the solution pipe part is disposed on the upper side of the first space; and the solution pipe part may spray a nutrient solution, supplied from the solution supply line, into the first space.

The solution pipe part may include: a first solution pipe flow path connected to the solution supply line at one end thereof, and configured to allow a nutrient solution to be introduced thereinto; a solution pipe spray flow path bent or branched to spray the nutrient solution, introduced from the first solution pipe flow path, into the first space, and formed such that an end thereof is disposed on an upper side of the first space; and a second solution pipe flow path disposed between the first solution pipe flow path and the solution pipe spray flow path; and the second solution pipe flow path may include a plurality of second solution pipe flow paths that are arranged to extend in a modular manner according to the number of stackable accommodation parts stacked so that the length of the solution pipe part can be adjusted.

The support part may include: an inclined surface configured such that a bottom thereof is formed to be inclined toward one side so that a vertical width of the second space becomes wider toward the one side; and a solution discharge outlet disposed at a lower end of the inclined surface, and connected to a solution discharge flow path.

The crop cultivation apparatus may further include an air supply line extending to the individual layers of the shelf case, connected to the individual cultivation modules, and configured to supply air to the second space.

The crop cultivation apparatus may further include an air supply inlet disposed on one side of the support part, connected to the air supply line, and configured to supply air to the second space.

The crop cultivation apparatus may further include an air supply pipe connected to the air supply inlet, formed in a ring shape extending along an inner surface of the support part, disposed in the second space, and provided with a plurality of pores so that air introduced from the air supply inlet is evenly distributed throughout the second space.

The crop cultivation apparatus may further include a filter part disposed between the stackable accommodation part and the support part and configured to prevent soil, placed in the first space, from being introduced into the second space.

The above-described crop cultivation apparatus equipped with stackable cultivation modules according to one embodiment of the present invention may have at least one of the following effects:

First, there are effects in which a user may preset the type of crops to be grown in the cultivation module for each loading space and may adjust the size of a cultivation space through the adjustment of the size of the first space by stacking the stackable accommodation parts of one or more cultivation modules on top of each other according to the set length of the crops.

Furthermore, when the cultivation space needs to be changed by replacing crops after the harvest season, the number of stackable accommodation parts stacked may be adjusted again as needed. In other words, there is the effect in which the size of the cultivation space may be adjusted according to the size of crops to be grown or a cultivation environment.

Furthermore, the user may adjust the length of the solution pipe part by adjusting the number of second solution pipe flow paths of the solution pipe part according to the number of stackable accommodation parts stacked, thereby providing the effect of naturally supplying the nutrient solution to the cultivation space easily.

Furthermore, when the user transfers the stackable accommodation part of the cultivation module disposed in the loading space in order to harvest crops, the solution pipe line is coupled to the solution pipe coupling portions disposed at the rear of the support part in the direction opposite to a transfer direction, i.e., on the rear side, in the shelf case, the solution discharge line is located at the lower end of the support part, and the air supply line is also located at the rear of the support part. Accordingly, there is the effect in which the stackable accommodation part may be easily transferred without interference with the various types of lines. As a result, there is the effect in which the user may easily take the stackable accommodation part out to the outside without any interference manually or by using the crane described above.

Moreover, in the process in which the stackable accommodation part of the cultivation module is transferred, the solution pipe part is also naturally separated from the solution supply line in the state of being coupled to the stackable accommodation part. In contrast, when the stackable accommodation part is seated on the support part, the solution pipe part is coupled back to the solution supply line. Accordingly, there is an effect in which the supply of the nutrient solution may be easily determined depending on whether transfer is performed.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing the overall configuration of a crop cultivation apparatus according to an embodiment of the present invention;

FIG. 2 is a diagram showing a configuration in which a cultivation module is installed on a shelf of the crop cultivation apparatus according to the embodiment of the present invention;

FIG. 3 is an exploded view of a cultivation module of the crop cultivation apparatus according to the embodiment of the present invention;

FIG. 4 is a semi-see-through view of the cultivation module of the crop cultivation apparatus according to the embodiment of the present invention;

FIG. 5 is a diagram showing the support part of a cultivation module of the crop cultivation apparatus according to the embodiment of the present invention;

FIG. 6 is a diagram showing the stackable accommodation part of the cultivation module of the crop cultivation apparatus according to the embodiment of the present invention;

FIG. 7 is a diagram showing a configuration in which the stackable accommodation parts of cultivation modules of the crop cultivation apparatus according to the embodiment of the present invention are stacked on top of each other; and

FIG. 8 is a diagram showing a configuration in which the stackable accommodation parts of cultivation modules of the crop cultivation apparatus according to the embodiment of the present invention are stacked on top of each other and thus a case portion and a coupling portion are coupled to each other.

### DETAILED DESCRIPTION

Embodiments of the present invention will be described in detail below with reference to the accompanying drawings so that those of ordinary skill in the art to which the present invention pertains can easily implement the present invention. The present invention may be implemented in many different forms and is not limited to the structures or methods described herein.

An embodiment of the present invention relates to a crop cultivation apparatus equipped with stackable cultivation modules 200 that can adjust the size of a cultivation space in a stacked manner according to the root length of soil crops. Hereinafter, this apparatus will be briefly described as the “crop cultivation apparatus.”

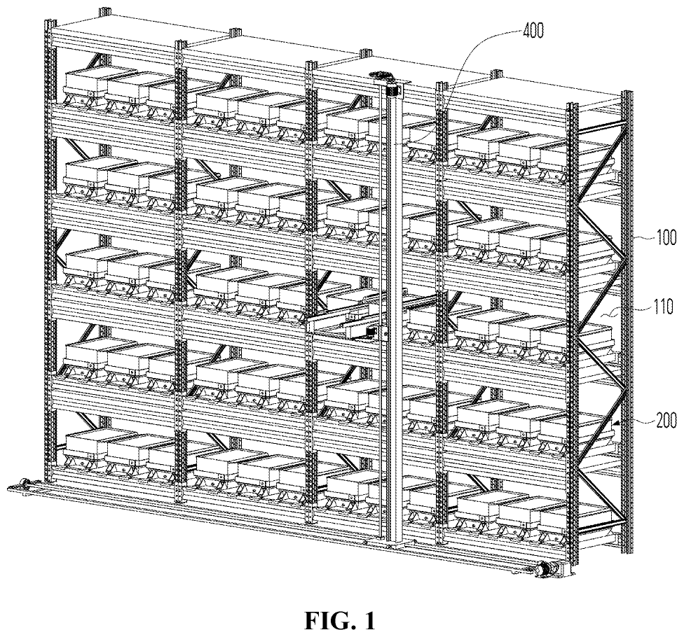

Furthermore, in the detailed description of the present invention, based on FIG. 1, the direction from a shelf case 100 to a crane 400 is defined as the direction toward one side, the direction from the crane 400 to the shelf case 100 is defined as the direction toward the other side, the upward direction from the ground is defined as the upward direction, and the downward direction from the ground is defined as the downward direction, and the direction toward both sides of each of the cultivation modules 200 is defined as the lateral direction. However, it should be noted that these directions are intended merely for ease of description and the directions of the present invention are not limited thereto.

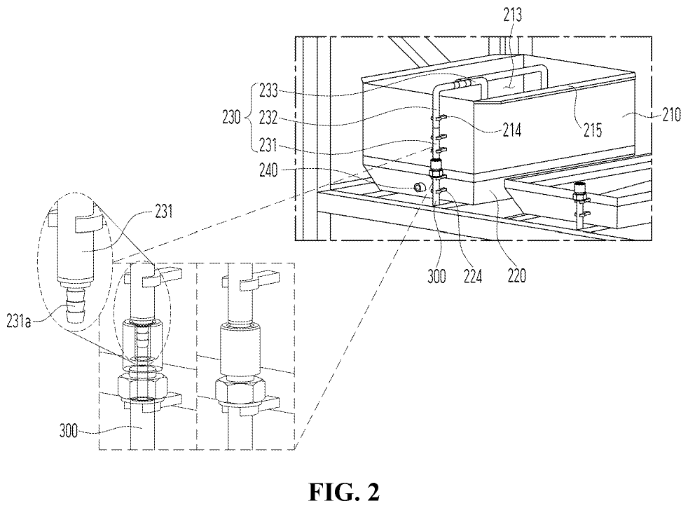

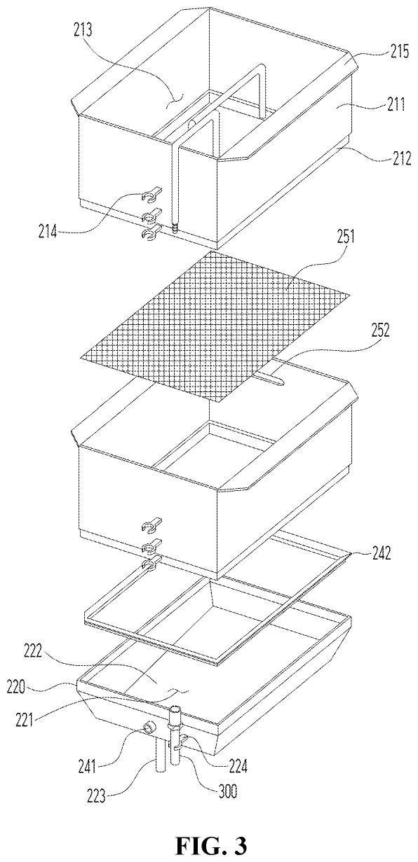

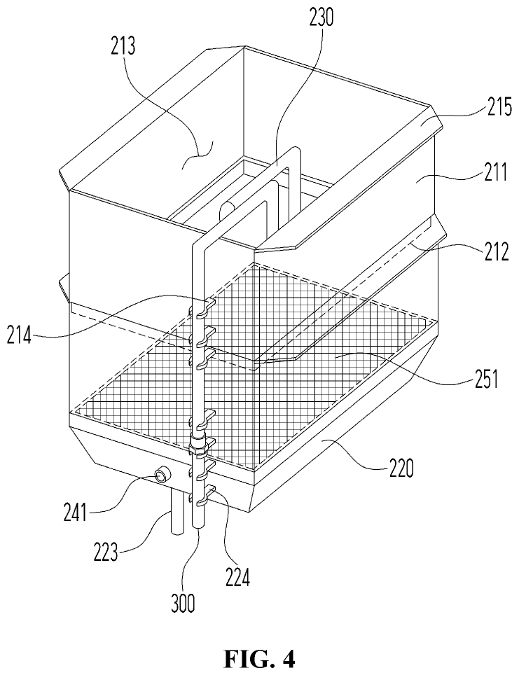

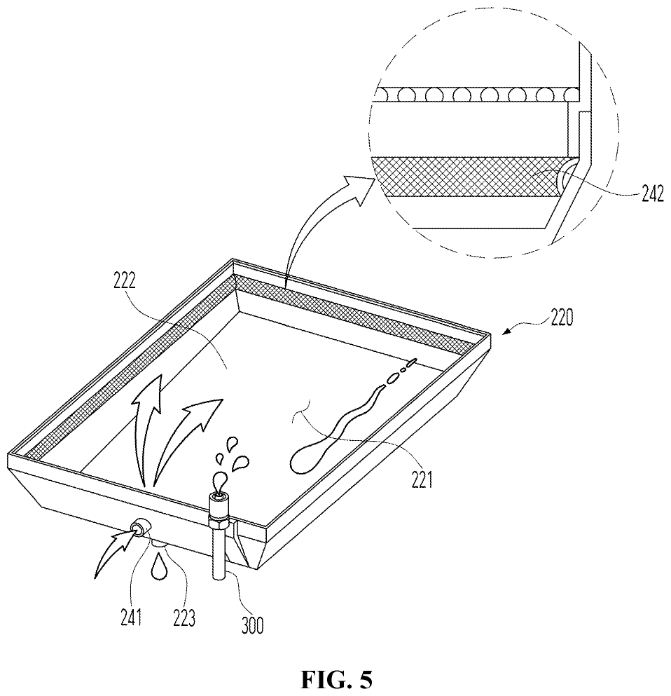

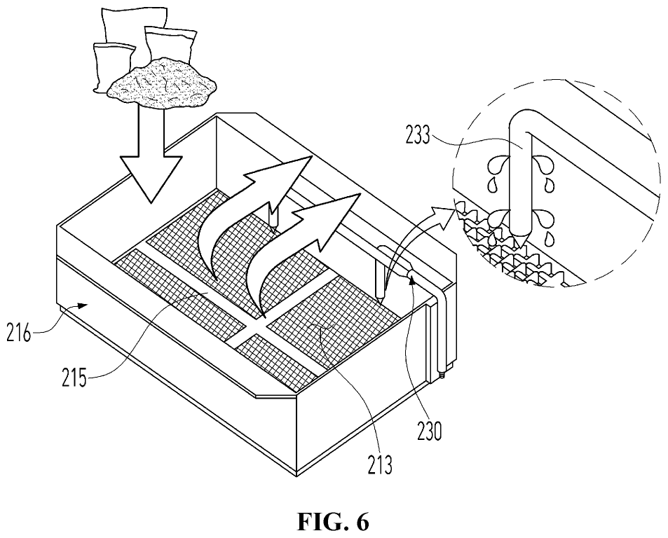

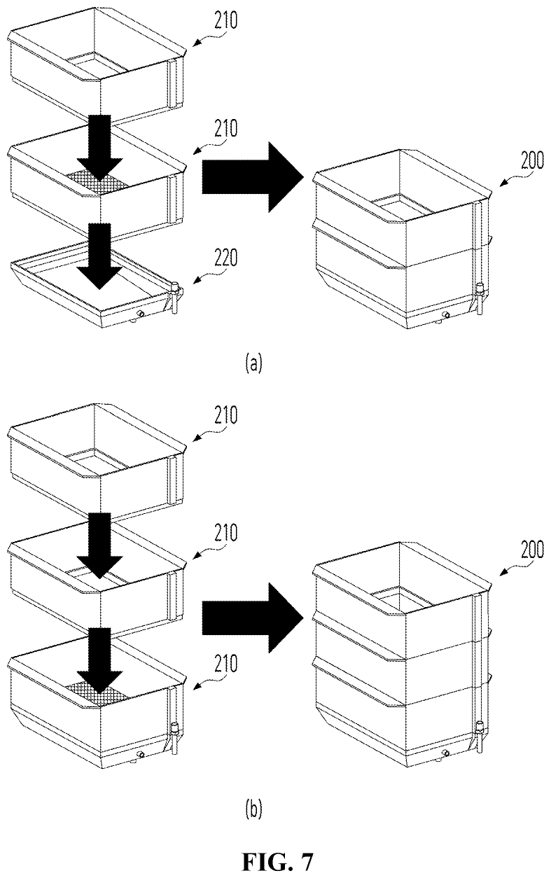

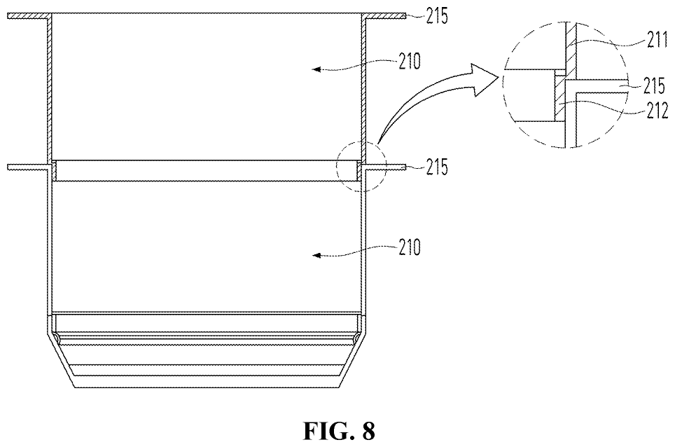

FIG. 1 is a perspective view showing the overall configuration of a crop cultivation apparatus according to an embodiment of the present invention, FIG. 2 is a diagram showing a configuration in which a cultivation module is installed on a shelf of the crop cultivation apparatus according to the embodiment of the present invention, FIG. 3 is an exploded view of a cultivation module of the crop cultivation apparatus according to the embodiment of the present invention, FIG. 4 is a semi-see-through view of the cultivation module of the crop cultivation apparatus according to the embodiment of the present invention, FIG. 5 is a diagram showing the support part of a cultivation module of the crop cultivation apparatus according to the embodiment of the present invention, FIG. 6 is a diagram showing the stackable accommodation part of the cultivation module of the crop cultivation apparatus according to the embodiment of the present invention, FIG. 7 is a diagram showing a configuration in which the stackable accommodation parts of cultivation modules of the crop cultivation apparatus according to the embodiment of the present invention are stacked on top of each other, and FIG. 8 is a diagram showing a configuration in which the stackable accommodation parts of cultivation modules of the crop cultivation apparatus according to the embodiment of the present invention are stacked on top of each other and thus a case portion and a coupling portion are coupled to each other.

Referring to FIGS. 1 to 8, the crop cultivation apparatus equipped with stackable cultivation modules according to the embodiment of the present invention may include: a shelf case 100 composed of one or more layers, and provided with loading spaces 110 in the respective layers; one or more cultivation modules 200 disposed in the loading spaces 110 of the shelf case 100, and configured to provide respective cultivation spaces for cultivating soil crops therein and to have an adjustable height; a solution supply line 300 extending from a nutrient solution supply unit for supplying a nutrient solution to the individual layers of the shelf case 100, and connected to the cultivation modules 200; a solution discharge line extending from a nutrient solution discharge unit for discharging a supplied nutrient solution to the individual layers of the shelf case 100, and connected to the cultivation modules 200; and a crane 400 configured to transfer the cultivation modules 200 from the shelf case 100.

Furthermore, the crop cultivation apparatus equipped with stackable cultivation modules according to the embodiment of the present invention may further include an air supply line extending from an air supply unit to the individual layers of the shelf case 100 and connected to the cultivation modules 200 in order to supply air (oxygen).

The shelf case 100 may extend upward to have one or more layers, preferably two or more layers, and loading spaces 110 may be formed in the respective layers. In this case, as the height of the cultivation modules 200 is adjusted, the loading spaces 110 of the shelf case 100 may be designed and set to a height desired by a user, and there is no limitation to the heights of the loading spaces 110.

The solution supply line 300 is a means that is arranged to branch from the nutrient solution supply unit where the nutrient solution is stored to the individual cultivation modules 200 arranged in the individual layers of the shelf case 100, more specifically the loading spaces 110, and provides a flow path for supplying a nutrient solution to the cultivation spaces formed in the cultivation modules 200. This solution supply line 300 may be branched from the nutrient solution supply unit to the individual layers of the shelf case 100, and may be branched again to the individual cultivation modules 200 in each of the layers. In this case, the solution supply line 300 may move a nutrient solution in the direction from the nutrient solution supply unit to the cultivation modules 200 in order to supply the nutrient solution to the cultivation spaces.

The solution discharge line is a means that provides a flow path for merging and discharging a discharged nutrient solution into the nutrient solution discharge unit for storing and processing a nutrient solution when the nutrient solution supplied to the individual cultivation modules 200 is discharged to the cultivation spaces. In more detail, the solution discharge line may branch from the nutrient solution discharge unit to the individual layers of the shelf case 100, and may branch again to the individual cultivation modules 200 in each of the layers. However, the solution discharge line is a line for discharging a nutrient solution, so that the direction in which a nutrient solution is discharged may be the direction from the cultivation modules 200 to the nutrient solution discharge unit.

The air supply line is a means that is arranged to branch such that air can be supplied from the air supply unit for blowing air or discharging air using air pressure difference to the individual cultivation modules 200 arranged in the individual layers of the shelf case 100, more specifically the loading spaces 110, and provides a flow path for supplying air to the cultivation spaces formed in the respective cultivation modules 200, more specifically the soil inserted into the cultivation spaces. This air supply line may branch from the air supply unit to the individual layers of the shelf case 100, and may branch again to the individual cultivation modules 200 in each of the layers. In this case, the air supply line may move air in the direction from the air supply unit to the cultivation modules 200 to supply the air to the cultivation spaces.

Next, the detailed structure of each of the cultivation modules 200 will be described in detail. The cultivation module 200 of the present invention is a modular means that provides a cultivation space where soil and crops can be planted to cultivate soil crops therein, and at the same time, may adjust the height of the cultivation space as needed.

In more detail, the cultivation module 200 may include: a stackable accommodation part 210 formed in a box shape with an open top and bottom, provided with a first space 213 for planting soil and crops inside, and arranged to be stackable on top of another stackable accommodation portion in the vertical direction; a support part 220 formed in a box shape with an open top, coupled to the bottom of the stackable accommodation part 210 on the lowest side of stackable accommodation parts 210 (when there are a plurality of stackable accommodation parts 210), and provided with a second space 221 to which air and a nutrient solution are supplied; a solution pipe part 230 disposed on one side of the stackable accommodation part 210, coupled to the solution supply line 300, and configured to supply a nutrient solution to the first space 213; an air supply part 240 disposed in the support part 220, coupled to the air supply line, and configured to supply air to the second space 221 of the support part 220; and a filter part 250 disposed between the stackable accommodation part 210 and the support part 220, and configured to separate the first space 213 and the second space 221 from each other and to prevent the soil in the first space 213 from being discharged to the second space 221. In this case, a space into which the first space 213 and the second space 221 are combined may be defined as the above-described cultivation space. When a plurality of stackable accommodation parts 210 are stacked on top of each other, a space into which pluralities of first spaces 213 and second spaces 221 are combined may be defined as a cultivation space. The plurality of first spaces 213 are also defined and described as the first space 213 below.

The stackable accommodation part 210 is a means that may be coupled to another stackable accommodation part 210 in the vertical direction or may be coupled to the support part 220 in order to place soil and plant crops therein. The stackable accommodation part 210 may include: a case portion 211 formed in a box shape (a rectangular box shape in the drawing) with an open top and bottom, and configured to form the first space 213; and a coupling portion 212 bent to be stepped from the bottom of the case portion 211 toward the center of the case portion 211, bent to extend downward again, and configured to be coupled to the top of the case portion 211 or to the top of the support part 220. That is, the coupling portion 212 is formed to have a section that is narrower than the top surface of the case portion 211, so that the coupling portion 212 can be fitted into the top of the case portion 211. Accordingly, the stackable accommodation parts 210 may be stacked on top of each other because the case portions 211 are disposed on upper sides and the coupling portions 212 are disposed under the case portions 211.

Furthermore, the stackable accommodation part 210 may be provided with support portions 215 that are bent and extend to both sides at the top. The support portions 215 are means that are supported by the crane 400, which will be described later. The stackable accommodation part 210 of the cultivation module 200 may be transferred to a desired location through the support portions 215. In addition, the support portions 215 are bent and extend to both sides at the top of the case portion 211, so that, when the stackable accommodation parts 210 are stacked on top of each other, the coupling portions 212 can be stably supported.

Furthermore, first solution coupling portions 214 configured to allow portions of the solution pipe part 230, to be described later, to be coupled thereto may be further provided on the other side of the stackable accommodation part 210. In more detail, the first solution pipe coupling portions 214 are means that allow the solution pipe part 230 to be selectively coupled thereto. The first solution pipe coupling portions 214 may be formed in a ring or hook shape for fitting the solution pipe part 230 on one side of the stackable accommodation part 210. There is no limitation to a coupling method. In addition, the first solution pipe coupling portions 214 are disposed on the other side of the stackable accommodation part 210. Accordingly, the solution pipe part 230 to be coupled to the first solution pipe coupling portions 214 does not interfere even when the stackable accommodation part 210 is transferred to one side by the crane 400, so that there is the effect of allowing the stackable accommodation part 210 to be easily transferred to the outside.

The support part 220 may be formed as a support structure that allows the stackable accommodation part 210 to be seated thereon by fitting the lower side of the stackable accommodation part 210, more specifically the coupling portion 212 of the stackable accommodation part 210, into the top thereof. In this case, the top of the support part 220 has the same size as the top of the case portion 211 of the stackable accommodation part 210, so that the coupling portion 212 of the stackable accommodation part 210 described above can be fitted into the top of the support part 220. The support part 220 may include an inclined surface 222 configured such that the bottom thereof is formed to be inclined toward the other side so that the vertical width of the second space 221 becomes wider toward one side, and a solution discharge outlet 223 disposed at the lower end of the other side of the inclined surface 222 and connected to a solution discharge flow path.

The inclined surface 222 is the bottom surface of the support part 220. The inclined surface 222 is a means that is inclined downward toward the other side, thereby allowing the nutrient solution, discharged from the soil, to flow to the other side by means of gravity. In this case, the lower end surface of the support part 220 may be formed as a flat surface, and only the bottom surface formed in the second space 221 may be inclined to the other side. This is intended to allow the support part 220 to be placed in the horizontal direction on a support surface when the support part 220 is loaded into the loading space 110 of the shelf case 100

Furthermore, the solution discharge outlet 223 is a means that is formed in an opening shape in the bottom of the other side of the inclined surface 222, i.e., the lowest portion of the bottom surface of the inclined surface 222, and is connected to the solution discharge line so that the nutrient solution discharged from the soil can be discharged into the solution discharge line. As the solution discharge outlet 223 is disposed in the lower end of the other side of the inclined surface 222, the nutrient solution discharged from the soil may flow down to the bottom along the inclined surface 222 by means of gravity and then be discharged into the solution discharge line through the solution discharge outlet 223.

Furthermore, a second solution pipe coupling portion 224 configured to allow a solution supply line 300, to be described later, to be coupled thereto may be disposed at the other end of the support part 220. In more detail, the second solution pipe coupling portion 224 is a means that allows one end of the solution supply line 300 to be selectively coupled thereto. The second fluid coupling portion 224 may be formed in a ring or hook shape for fitting the solution supply line 300 on one side of the support part 220, and there is no limitation to a coupling method. In addition, the second solution pipe coupling portion 224 is disposed at the other end of the support part 220, and is arranged to be parallel with the first solution coupling portions 214 in the vertical direction when the stackable accommodation part 210 is seated. There are the effects in which the solution pipe part 230 to be coupled to the first solution pipe coupling portions 214 is easily coupled to the solution supply line 300, and at the same time, the liquid pipe part 230 does not interfere even in the case where the stackable accommodation part 210 is transferred to one side by the crane 400.

The solution pipe part 230 is a means that is connected to the solution supply line 300 and provides a flow path for supplying a nutrient solution to the first space 213. The solution pipe part 230 may include: a first solution pipe flow path 231 connected to one end of the solution supply line 300 at one end thereof and configured to allow a nutrient solution to be introduced thereinto; a solution pipe spray flow path 233 bent or branched to spray the nutrient solution, introduced from the first solution pipe flow path 231, toward the upper side of the first space 213; and a second solution pipe flow path 232 disposed between the first solution pipe flow path 231 and the solution pipe spray flow path 233 to connect the first solution pipe flow path 231 and the solution pipe spray flow path 233, thereby providing the nutrient solution, introduced into the first solution pipe flow path 231, to the solution pipe spray flow path 233. In this case, the first solution pipe flow path 231, solution pipe spray flow path 233, and second solution pipe flow path 232 of the pipe fluid portion 230 may be arranged to be selectively coupled to each other or separated from each other.

The first solution pipe flow path 231 is a means that is coupled to the solution supply line 300 and allows a nutrient solution to be introduced from the solution supply line 300. A packing 231a may be formed at one end of the first solution pipe flow path 231. In this case, the packing 231a has a plurality of multi-stage portions spaced downward, thereby providing the effect of preventing the nutrient solution, introduced from the solution supply line 300, from being discharged to the outside.

Furthermore, when the stackable accommodation part 210 is transferred upward and separated from the support part 220 with the first solution pipe flow path 231 being coupled to the first solution pipe coupling portion 214 formed on the first solution pipe flow path 231 210, the first solution pipe flow path 231 is separated from the solution supply line 300. In contrast, when the stackable accommodation part 210 is coupled to the support part 220 again, the first solution pipe flow path 231 is coupled to the solution supply line 300 and thus receives a nutrient solution because the first solution pipe flow path 231 is coupled to the first solution pipe coupling portion 214. Accordingly, even when the stackable accommodation part 210 is re-seated on the support part 220 after transfer, there is the effect of ensuring that a nutrient solution is efficiently supplied to the cultivation space.

The second solution pipe flow path 232 is a means that extends a flow path for a nutrient solution in such a manner that one end thereof is coupled to the other end of the first solution pipe flow path 231 and the other end thereof is coupled to one end of the solution pipe spray flow path 233. In more detail, when the plurality of stackable accommodation parts 210 of a plurality of cultivation modules 200 are stacked on top of each other, one or more second solution pipe flow paths 232 may be arranged to adjust the length of a flow path according to the vertical length of the cultivation modules 200. When a plurality of second solution pipe flow paths 232 are connected to each other, the second solution pipe flow paths 232 may be combined and extend in the vertical direction. In other words, the second solution pipe flow path 232 may be utilized as a modular means that can adjust the length of the solution pipe part 230 depending on the situation where the stackable accommodation parts 210 are stacked on top of each other.

The solution pipe spray flow path 233 is a means that sprays the nutrient solution from the top portion of the cultivation space of the cultivation module 200, more specifically the top portion of the first space 213, into the first space 213. In more detail, the solution pipe spray flow path 233 is bent toward the top portion of the first space 213 with one end thereof coupled to the other end of the second solution pipe flow path 232, and may be branched in the bent state as needed so that the other end thereof can be disposed in the top portion of the first space 213. Furthermore, a spray hole may be formed at the other end of the solution pipe spray flow path 233 to spray the nutrient solution toward the top portion of the first space 213. In this case, the spray hole may be shaped to become narrower toward the other end thereof. However, there is no limitation to the shape of the spray hole as long as it is shaped to spray the nutrient solution.

The air supply part 240 is a means that is disposed in the support part 220, is connected to an air supply line, and supplies air to the second space 221 inside the support part 220. In more detail, the air supply part 240 may include: an air supply inlet 241 formed in an opening shape, disposed on the other side of the support part 220, and connected to the air supply line; and an air supply pipe configured to form a ring-shaped flow path along the inner surface of the support part 220 in order to supply the air, introduced from the air supply inlet 241, evenly throughout the area of the second space 221 and at the same time, to prevent the nutrient solution and the like from leaking to the outside from the second space 221, and provided with a plurality of pores. With the above configuration, the air supplied from the air supply line may be evenly supplied to the second space 221 through the air supply pipe through the air supply inlet 241. Additionally, air may be supplied to the soil in the first space 213 by air pressure attributable to the supply of air. Accordingly, there is the effect of efficiently performing root respiration as needed.

The filter part 250 is a means that is disposed between the stackable accommodation part 210 and the support part 220, separates the first space 213 of the stackable accommodation part 210 and the second space 221 of the support part 220 from each other, prevents the soil in the first space 213 from flowing into the second space 221, and also filters the nutrient solution supplied to the first space 213 or discharged to the second space 221. In more detail, the filter part 250 may include: a filter net 251 having a section corresponding to the sections of the first space 213 and the second space 221 and provided with minute pores formed therein; and filter supports 252 disposed outside the filter net 251 and configured to support the filter net 251. The filter net 251 may be securely fixed by the filter supports 252 despite the pressure of the nutrient solution that is discharged from the first space 213 to the second space 221.

Based on the above-described configuration, a configuration in which the stackable accommodation parts 210 of the cultivation modules 200 are arranged or combined and stacked on top of each other in the loading space 110 of the shelf case 100 will be described below.

Referring to FIG. 7, the support part 220 of the cultivation module 200 may be selectively disposed in the loading space 110 of the shelf case 100, and may basically be maintained in a coupled state. In this state, a user may preset the type of crops to be grown in the cultivation module 200 for each loading space 110, and may adjust the size of a cultivation space through the adjustment of the size of the first space 213 by stacking the stackable accommodation parts 210 of one or more cultivation modules 200 on top of each other according to the set length of the crops.

Furthermore, when the cultivation space needs to be changed by replacing crops after the harvest season, the number of stackable accommodation parts 210 stacked may be adjusted again as needed. In other words, there is the effect in which the size of the cultivation space may be adjusted according to the size of crops to be grown or a cultivation environment.

Furthermore, in the state in which the cultivation modules 200 are disposed in the loading space, the length of solution pipe part 230 may be adjusted according to the number of stackable accommodation parts 210 stacked. In more detail, the user may adjust the length of the solution pipe part 230 by adjusting the number of second solution pipe flow paths 232 of the solution pipe part 230 according to the number of stackable accommodation parts 210 stacked, thereby providing the effect of naturally supplying the nutrient solution to the cultivation space easily.

Furthermore, when the user transfers the stackable accommodation part 210 of the cultivation module 200 placed in the loading space 110 in order to harvest crops, the solution pipe line is coupled to the solution pipe coupling portions 224 disposed at the rear of the support part 220 in the direction opposite to a transfer direction, i.e., on the rear side, in the shelf case 100, the solution discharge line is located at the lower end of the support part 220, and the air supply line is also located at the rear of the support part 220. Accordingly, there is the effect in which the stackable accommodation part 210 may be easily transferred without interference with the various types of lines. As a result, the user may easily take the stackable accommodation part 210 out to the outside without any interference manually or by using the crane 400 described above.

Moreover, in the process in which the stackable accommodation part 210 of the cultivation module 200 is transferred, the solution pipe part 230 is also naturally separated from the solution supply line 300 in the state of being coupled to the stackable accommodation part 210. In contrast, when the stackable accommodation part 210 is seated on the support part 220, the solution pipe part 230 is coupled back to the solution supply line 300. Accordingly, there is an effect in which the supply of the nutrient solution may be easily determined depending on whether transfer is performed.

The present invention has been described so far with a focus on the exemplary embodiments. It will be understood by those of ordinary skill in the art to which the present invention pertains that the present invention may be implemented in a modified form without departing from the essential features of the present invention. Therefore, the disclosed embodiments should be taken into consideration in an illustrative sense rather than a restrictive sense. The scope of the present invention is defined based on the attached claims rather than the foregoing detailed description, and all differences falling within the scopes equivalent to the claims should be construed as being included in the present invention.

What is claimed is:

1. A crop cultivation apparatus comprising:
a shelf case composed of one or more layers, and provided with loading spaces in the respective layers;
one or more cultivation modules disposed in the loading spaces of the shelf case, and configured to provide respective cultivation spaces for cultivating soil crops therein;
a solution supply line extending to the individual layers of the shelf case, branched to the individual cultivation modules, and configured to supply a nutrient solution to the cultivation spaces; and
a solution discharge line extending to the individual layers of the shelf case, branched to the individual cultivation modules, and configured to discharge a nutrient solution from the cultivation spaces;
wherein each of the cultivation modules includes:
one or more stackable accommodation parts each formed in a box shape with an open top and bottom, and each provided with a first space formed therein and a coupling portion formed at a lower end thereof; and
a support part formed in a box shape with an open top, and provided with a second space that communicates with the cultivation space of the cultivation module when a top thereof is coupled into a coupling portion of another stackable accommodation part; and
wherein the stackable accommodation parts are provided in a modular form so that a height of the first space can be adjusted in such a manner that the stackable accommodation parts are stacked on top of each other in a vertical direction by fitting the coupling portion into a top of another stackable accommodation part.

2. The crop cultivation apparatus of claim 1, wherein:
each of the stackable accommodation part includes a case portion formed in a rectangular box shape with an open top and bottom and provided with the first space disposed therein;
the coupling portion is formed to have a section that is narrower than a section of the case portion at a lower end of the case portion; and
the stackable accommodation parts are stacked on top of each other by fitting the coupling portion of another stackable accommodation part into a top of the case portion.

3. The crop cultivation apparatus of claim 1, wherein:
the cultivation module further includes a solution pipe part configured such that one end thereof is connected to the solution supply line and a remaining end thereof is connected to the stackable accommodation part so that the remaining end of the solution pipe part is disposed on an upper side of the first space; and
the solution pipe part sprays a nutrient solution, supplied from the solution supply line, into the first space.

4. The crop cultivation apparatus of claim 3, wherein:
the solution pipe part includes:
a first solution pipe flow path connected to the solution supply line at one end thereof, and configured to allow a nutrient solution to be introduced thereinto;
a solution pipe spray flow path bent or branched to spray the nutrient solution, introduced from the first solution pipe flow path, into the first space, and formed such that an end thereof is disposed on an upper side of the first space; and
a second solution pipe flow path disposed between the first solution pipe flow path and the solution pipe spray flow path; and
the second solution pipe flow path includes a plurality of second solution pipe flow paths that are arranged to extend in a modular manner according to a number of stackable accommodation parts stacked so that a length of the solution pipe part can be adjusted.

5. The crop cultivation apparatus of claim 1, wherein the support part includes:
an inclined surface configured such that a bottom thereof is formed to be inclined toward one side so that a vertical width of the second space becomes wider toward the one side; and
a solution discharge outlet disposed at a lower end of the inclined surface, and connected to a solution discharge flow path.

6. The crop cultivation apparatus of claim 1, further comprising an air supply line extending to the individual layers of the shelf case, connected to the individual cultivation modules, and configured to supply air to the second space.

7. The crop cultivation apparatus of claim 6, further comprising an air supply inlet disposed on one side of the support part, connected to the air supply line, and configured to supply air to the second space.

8. The crop cultivation apparatus of claim 7, further comprising an air supply pipe connected to the air supply inlet, formed in a ring shape extending along an inner surface of the support part, disposed in the second space, and provided with a plurality of pores so that air introduced from the air supply inlet is evenly distributed throughout the second space.

9. The crop cultivation apparatus of claim 1, further comprising a filter part disposed between the stackable accommodation part and the support part and configured to prevent soil, placed in the first space, from being introduced into the second space.
